(19) United States
(12) Patent Application Publication
(10) Pub. No.: US 2010/0320968 A1
(43) Pub. Date: Dec. 23, 2010

(54) ELECTRONIC APPARATUS WITH A FUNCTION FOR CHARGING FOR ITSELF

(75) Inventors: KIM-YEUNG SIP, Shenzhen City (CN); XIAO-GUANG SU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/512,039

(22) Filed: Jul. 30, 2009

(30) Foreign Application Priority Data
Jun. 19, 2009 (CN) 200910303459.8

(51) Int. Cl. H02J 7/00

(52) U.S. Cl. 320/114

(57) ABSTRACT

An electronic apparatus with a function for charging for itself is provided. The apparatus comprises a base part and a cover part, the cover part is connected to the base part through a slide mechanism and the cover part can slide along the base part through the slide mechanism. The electronic apparatus further comprises an electromagnetic induction device. The electromagnetic induction device comprises a conductor group and a first magnetic object group. During the process of the cover part sliding along the base part, the conductor group and a magnetic field make relative movement to generate induced current. After converted to direct current (DC) by a rectifier, the induced current is input to a battery of the apparatus to charge for the battery.

### BACKGROUND

1. Technical Field

The present disclosure relates to an electronic apparatus with a function for charging for itself.

2. Description of Related Art

Generally, a battery is needed to enable an electronic apparatus to work. When the energy of the battery is used up, meanwhile, the charger is not available to the user or there is no power source to recharge the battery, the electronic apparatus cannot work as needed. Thus, some urgent things can not be deal with using the apparatus.

### BRIEF DESCRIPTION OF THE DRAWINGS

The components of the drawings are not necessarily drawn to scale, the emphasis instead being placed upon clearly illustrating the principles of the electronic apparatus. Moreover, in the drawings, like reference numerals designate corresponding parts throughout several views.

FIG. 1 is an isometric view of an electronic apparatus with a function for charging for itself in accordance with an exemplary embodiment.

FIGS. 2 and 3 are schematic views of an electromagnetic induction device being assembled into the electronic apparatus of FIG. 1 in accordance with a first exemplary embodiment.

FIG. 4 is a schematic circuit diagram of the electromagnetic induction device charging for the apparatus of FIG. 1, in accordance with an exemplary embodiment.

### DETAILED DESCRIPTION

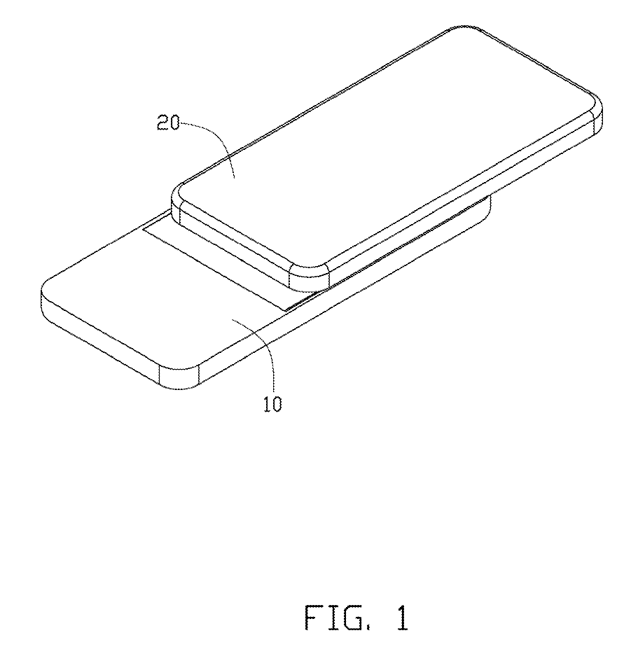

FIG. 1 is an isometric view of an electronic apparatus with a function for charging for itself (hereinafter “the apparatus”) in accordance with an exemplary embodiment. The apparatus includes a base part 10 and a cover part 20. The cover part 20 is connected to the base part 10 through a slide mechanism. The cover part 20 can slide along the base part 10 through the slide mechanism. In the present embodiment, the electronic apparatus is a cell phone.

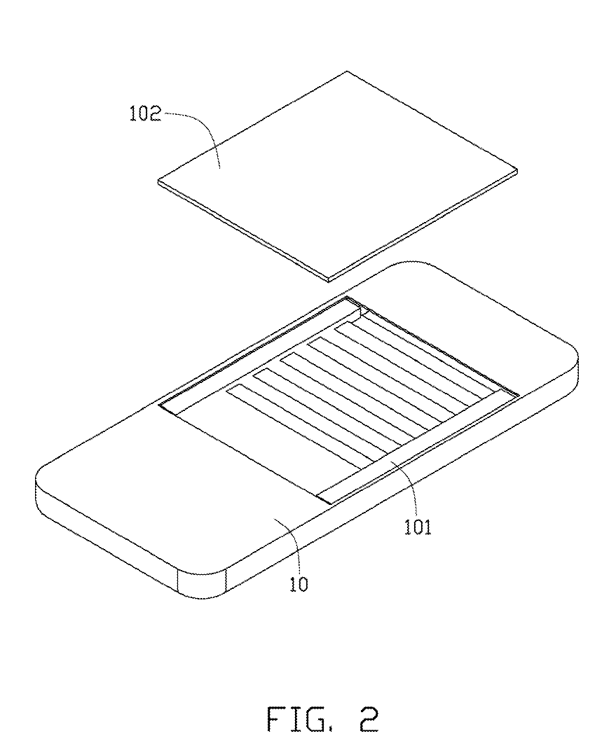

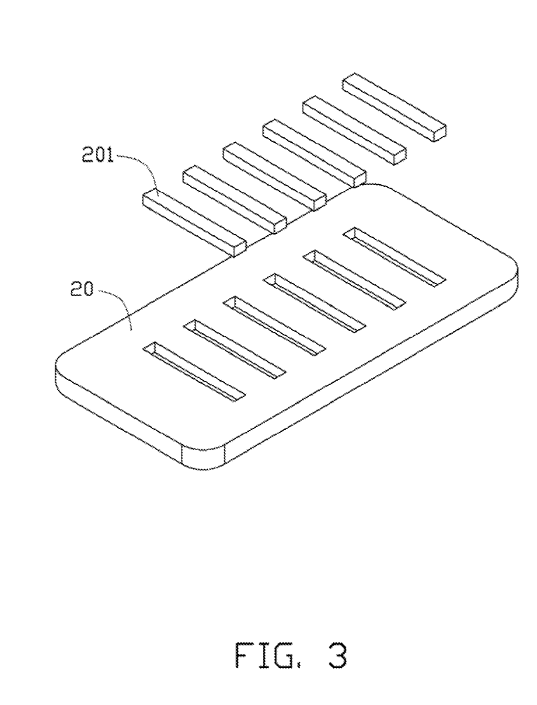

The apparatus further includes an electromagnetic induction device. FIG. 2 and FIG. 3 are the schematic views of the electromagnetic induction device being assembled into the electronic apparatus of FIG. 1 in accordance with a first exemplary embodiment. The electromagnetic induction device includes a conductor group 101 and a first magnetic object group 201. In the first embodiment, as shown in FIG. 2, the conductor group 101 is assembled into the base part 10 and is covered by a shell 102 of the base part 10. As shown in FIG. 3, the first magnetic object group 201 is assembled into the cover part 20.

In a second embodiment, the conductor group 101 is assembled into the cover part 20, and the first magnetic object group 201 is assembled into the base part.

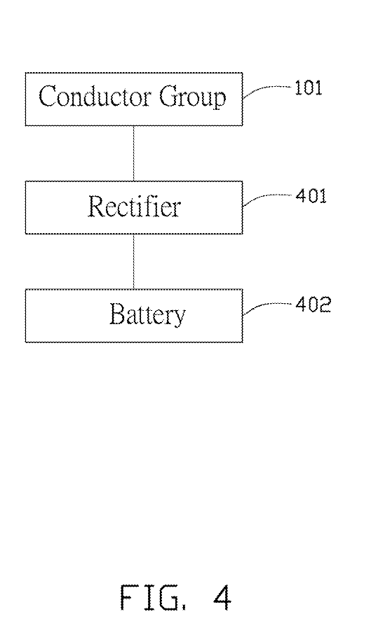

FIG. 4 is a circuit diagram of the electromagnetic induction device charging for the apparatus of FIG. 1. During the process of the cover part 20 sliding along the base part 10, the conductor group 101 cuts magnetic lines of a magnetic field generated by the first magnetic object group 201 to generate Induced current. The generated induced current is converted to direct current (DC) by a rectifier 401 and the converted direct current is input to a battery 402 of the apparatus to charge the battery 402. The rectifier 401 and the battery 402 can be disposed to any one of the base part 10 or the cover part 20.

The electromagnetic induction device may further include a second magnetic object group (not shown). In the first embodiment as described above, the second magnetic object group is assembled into the base part. In the second embodiment as described above, the second magnetic object group is assembled into the cover part 20. In both the first embodiment and the second embodiment, during the cover part 20 sliding along the base part 10, the conductor group 101 is always between the first magnetic object group 201 and the second magnetic object group. Thus, during the process of the cover part 20 sliding along the base part 10, the conductor group 101 cuts the magnetic lines of the magnetic field generated by the first magnetic object group 201 and the second magnetic object group to generate Induced current.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic apparatus with a function for charging for itself, comprising a base part and a cover part, the cover part being connected to the base part through a slide mechanism and the cover part can slide along the base part through the slide mechanism, wherein, the electronic apparatus further comprises an electromagnetic induction device, the electromagnetic induction device comprises a conductor group and a first magnetic object group, during the process of the cover part sliding along the base part, the conductor group and a magnetic field make relative movement to generates induced current; the electronic apparatus further comprises a rectifier for converting the induced current into direct current (DC), the induced current is input to a battery of the apparatus to charge the battery.

2. The apparatus as described in claim 1, wherein the conductor group is assembled into the base part and the first magnetic object group is assembled into the cover part.

3. The apparatus as described in claim 2, wherein the electromagnetic induction device further includes a second magnetic object group, the second magnetic object group is assembled into the base part, during the cover part sliding along the base part, the conductor group moves between the first magnetic object group and the second magnetic object group.

4. The apparatus as described in claim 1, wherein the conductor group is assembled into the cover part and the first magnetic object group is assembled into the base part.

5. The apparatus as described in claim 4, wherein the electromagnetic induction device further includes a second magnetic object group, the second magnetic object group is assembled into the cover part, during the cover part sliding along the base part, the conductor group is always between the first magnetic object group and the second magnetic object group.

6. The apparatus as described in claim 1, wherein the electronic apparatus is a cell phone.
